(19) United States
(12) Patent Application Publication
(10) Pub. No.: US 2026/0121704 A1
(43) Pub. Date: Apr. 30, 2026

(54) INTEGRATED SENSING AND COMMUNICATION DEVICE USING SINGLE ANALOG BEAM CODEBOOK SET IN NEAR-FIELD AND OPERATING METHOD THEREOF

(71) Applicant: UIF (University Industry Foundation), Yonsei University, Seoul (KR)

(72) Inventors: Chan-Byoung CHAE, Seoul (KR); Yoontae KIM, Seoul (KR); Siyun YANG, Seoul (KR); Hanju YOO, Seoul (KR)

(21) Appl. No.: 19/371,435

(22) Filed: Oct. 28, 2025

(30) Foreign Application Priority Data
Oct. 29, 2024 (KR) 10-2024-0149417

(51) Int. Cl. H04B 7/0456; H04B 7/0426

(52) U.S. Cl. CPC H04B 7/0456; H04B 7/043

(57) ABSTRACT

An integrated sensing and communication device and an operating method thereof that can detect objects located within a near-field region where beam squint phenomenon and near-field effect are applied with a minimum number of sensing operations using a single analog beam codebook set, thereby enabling fast and efficient detection of an object with low power.

### CROSS-REFERENCE TO RELATED APPLICATIONS

This application claims priority under 35 U.S.C. § 119 (a) to Korean Patent Application No. 10-2024-0149417, filed on Oct. 29, 2024, with the Korean Intellectual Property Office, the disclosure of which is incorporated herein in its entirety by reference.

### BACKGROUND

### 1. Technical Field

The present disclosure relates to an integrated sensing and communication device and an operating method thereof, and more particularly, to an integrated sensing and communication device using a single analog beam codebook set in a near field and an operating method thereof.

### 2. Description of the Related Art

Recently, the number of vehicles equipped with driver assistance features, such as autonomous driving and Advanced Driver Assistance Systems (ADAS), has been increasing. Consequently, many vehicles currently on the market are being equipped with various devices to support driving assistance features beyond simple driving functionality. Representative examples of these additional devices include communication devices that enable vehicle-to-vehicle (V2V) and vehicle-to-infrastructure (V2I) communication, and sensing devices that detect surrounding objects, such as LiDAR (Light Detection And Ranging) and radar. However, the increasing number and type of devices required for vehicles has led to increased vehicle design and manufacturing costs. To address this issue, Integrated Sensing and Communication (ISAC) devices, which integrate communication and sensing devices, are being developed.

Previously, communication devices and radar sensing devices had different configurations and used different frequency bands depending on their intended use. Consequently, integration between communication and sensing devices was difficult.

However, advancements in communication technology have led to a shortage of additional frequencies available for allocation, making it difficult to secure frequencies with a bandwidth wide enough to enable smooth communication. Accordingly, research is being conducted on communication devices that utilize frequencies in the millimeter wave (mm Wave) band (24 GHz to 100 GHz) or sub-terahertz (sub-THz) bands (100 GHz and above), which have not been widely used in communication devices, and the frequencies in these bands are frequency bands that can also be used in radar sensing devices.

Meanwhile, signals in ultra-high frequency bands, such as millimeter-wave and sub-terahertz bands, suffer from high path attenuation due to their short wavelengths, limiting their communication range. To overcome these limitations, beamforming techniques are being utilized to form highly directional beams based on massive MIMO systems that utilize large array antennas in which a plurality of antennas are arranged at even intervals.

In conventional MIMO systems, a digital beamforming architecture was mainly used, in which each of a plurality of antennas was equipped with a Digital to Analog Converter (DAC) that converts a digital signal into an analog signal, an RF chain that converts the converted analog signal into a high-frequency band signal, and a Power Amplifier (PA) that controls the intensity of the high-frequency band signal to be transmitted through the antenna. However, the digital beamforming architecture has the problem that the DAC, RF chain, and PA are all composed of circuits that consume a lot of power.

Additionally, MIMO systems can also utilize an analog beamforming architecture that converts an analog signal into a high-frequency band signal using a single RF chain, splits the converted high-frequency band signal into a plurality of signals, and then forms a beam by adjusting the phase using a plurality of phase shifters. However, since the upper limit of the number of independently transmittable data streams in a MIMO system is limited by the number of RF chains, the analog beamforming architecture has the limitation that it can only transmit one data stream at a time. Accordingly, hybrid beamforming architectures that combine digital beamforming architecture and analog beamforming architecture are increasingly being used.

Beamforming techniques significantly extend the communication range in the beam's intended direction, but as the beam width narrows, communication becomes virtually impossible in other directions. In other words, while the communication range increases, the angular range actually decreases. Additionally, in order for a transmitter and receiver to communicate, channel states for all combinations between a plurality of antennas must be estimated. This requires a complex channel estimation process: the transmitter transmits a preset reference signal, and the receiver determines the channel states from the transmitted reference signal and feeds it back to the transmitter.

To solve the above problem, a beam sweeping technique is also being utilized, which divides the entire communication target area into a plurality of zones with an angular range according to the beam width of the formed beam, and sequentially forms beams directed in each direction of the plurality of divided zones to cover the entire communication area.

The above-described hybrid beamforming architecture and beam sweeping technique are basically identical to the configuration and object detection operation of a radar sensing device. Therefore, the communication device and sensing device can be integrated into an ISAC device. When communication devices and sensing devices are integrated into an ISAC device, it may have the additional advantage of simplifying the complex channel estimation process by allowing the sensing signals to be utilized as they are when estimating the channel for performing communication, in addition to reducing costs.

However, the current ISAC device has a problem in that it cannot efficiently handle the beam squint phenomenon (beam squint effect) caused by the wide frequency bandwidth used for communication and the near-field effect that occurs at close range.

### SUMMARY

An object of the present disclosure is to provide an integrated sensing and communication device that can quickly and efficiently detect objects at close range with low power using a single analog beam codebook set, and an operating method thereof.

Another object of the present disclosure is to provide an integrated sensing and communication device using a single analog beam codebook set that can detect an object located in a near-field region where beam squint phenomenon and near-field effect are applied with a minimum number of sensing operations, and an operating method thereof.

According to one embodiment of the present disclosure, a method of operating an integrated sensing and communication device comprises the steps of: digitally precoding input data according to a digital beam codebook; receiving the digitally precoded data and converting it into an analog signal; and transmitting, during a sensing operation in a near-field region where a near-field effect is reflected in which a signal radiated from an array antenna appears as a spherical waveform, a sensing signal obtained by analog precoding the analog signal according to a near-field analog beam codebook set so that a beam is focused at a position of a plurality of designated angles and focusing distances within the near-field region and beam sweeping is performed once, to a plurality of antennas of the array antenna, the near-field analog beam codebook set being obtained by repeatedly calculating and accumulating a near-field analog sensing correlation that represents a position-specific gain reflecting a squinting effect and the near-field effect according to the frequency difference between the center frequency of a bandwidth and a subcarrier frequency while adjusting the distance at which an object is detected at a designated angle and focusing distance, and extracting a focusing distance that maximizes the accumulated near-field analog sensing correlation while the focusing distance changes at each designated angle within the near-field region.

According to another embodiment of the present disclosure, an integrated sensing and communication device comprises: a digital beamformer that digitally precodes input data according to a digital beam codebook; a plurality of RF chains that receive the digitally precoded data and convert it into an analog signal; and an analog beamformer that transmits, during a sensing operation in a near-field region where a near-field effect is reflected in which a signal radiated from an array antenna appears as a spherical waveform, a sensing signal obtained by analog precoding the analog signal according to a near-field analog beam codebook set so that a beam is focused at a position of a plurality of designated angles and focusing distances within the near-field region and beam sweeping is performed once, to a plurality of antennas of the array antenna, the near-field analog beam codebook set being obtained by repeatedly calculating and accumulating a near-field analog sensing correlation that represents a position-specific gain reflecting a squinting effect and the near-field effect according to the frequency difference between the center frequency of a bandwidth and a subcarrier frequency while adjusting the distance at which an object is detected at a designated angle and focusing distance, and extracting a focusing distance that maximizes the accumulated near-field analog sensing correlation while the focusing distance changes at each designated angle within the near-field region.

According to the integrated sensing and communication device of the present disclosure and the method of operating the same, an object located in a near-field region where the beam squint phenomenon and the near-field effect are applied can be detected with a minimum number of sensing operations using a single analog beam codebook set, thereby enabling fast and efficient detection of an object with low power.

### BRIEF DESCRIPTION OF THE DRAWINGS

FIG. 1 illustrates a hybrid beamforming architecture of an integrated sensing and communication device according to one embodiment.

FIG. 2 illustrates a beam sweeping technique.

FIG. 3 is a diagram illustrating the beam squint phenomenon.

FIG. 4 is a diagram illustrating the near-field effect.

FIG. 5 is a diagram illustrating analog sensing correlation in the near-field.

FIG. 6 is a diagram illustrating beam focusing in the near-field region.

FIG. 7 is a diagram illustrating a single analog beam codebook set according to one embodiment.

FIG. 8 illustrates an operating method of an integrated sensing and communication device according to one embodiment.

FIG. 9 is a diagram illustrating a computing environment including a computing device according to one embodiment.

### DETAILED DESCRIPTION OF THE INVENTION

Hereinafter, specific embodiments of the present disclosure will be described with reference to the drawings. The following detailed description is provided to help with comprehensive understanding of a method, a device, and/or a system described in this specification. However, this is only an example, and the present invention is not limited thereto.

In describing embodiments of the present disclosure, when it is determined that detailed description of well-known technologies related to the present disclosure may unnecessarily obscure the gist of embodiments, the detailed description will be omitted. Terms to be described below are terms defined in consideration of functions in the present disclosure, and may vary depending on the intention, practice, or the like of a user or operator. Therefore, the terms should be defined on the basis of the overall content of this specification. Terms used in the detailed description are only used to describe embodiments and should not be construed as limiting. Unless otherwise clearly specified, a singular expression includes the plural meaning. In this description, an expression such as “include” or “have” is intended to indicate certain features, numerals, steps, operations, elements, or some or combinations thereof, and should not be construed as excluding the presence or possibility of one or more other features, numerals, steps, operations, elements, or some or combinations thereof. Also, the terms “unit,” “device,” “module,” “block,” and the like described in this specification refer to units for processing at least one function or operation, which may be implemented by hardware, software, or a combination of hardware and software.

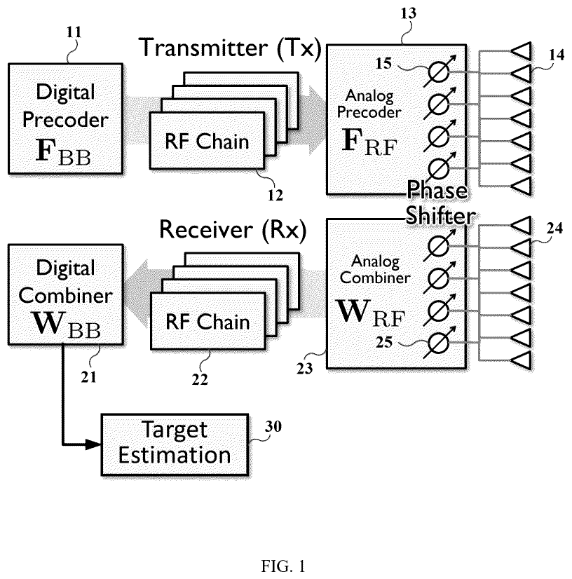

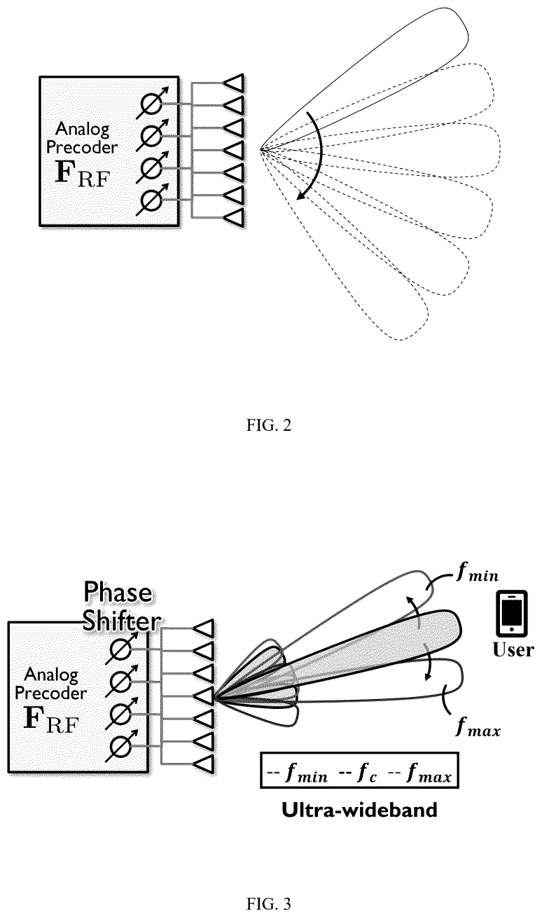

FIG. 1 illustrates a hybrid beamforming architecture of an integrated sensing and communication device according to one embodiment, and FIG. 2 illustrates a beam sweeping technique.

As illustrated in FIG. 1, a transmitter (TX) and a receiver (RX) having a hybrid beamforming architecture may include digital beamformers 11 and 21, a plurality of RF chains 12 and 22, and analog beamformers 13 and 23.

In the transmitter (TX), the digital beamformer 11 receives transmission data to be transmitted, multiplexes it, and adjusts its amplitude and phase to generate a plurality of digital signals. The plurality of RF chains 12 convert the plurality of digital signals generated by the digital beamformer 11 into analog signals. The analog beamformer 13 multiplexes the analog signals received from the plurality of RF chains 12 and adjusts their phases so that the transmission signals form at least one beam and are transmitted through a plurality of antennas 14. The analog beamformer 13 may include a plurality of phase shifters 15 to adjust the phase of each of the multiplexed analog signals.

In the transmitter (TX), the digital beamformer 11 can be referred to as a digital precoder that performs digital precoding on the received transmission data, and the analog beamformer 13 can be referred to as an analog precoder that performs analog precoding on a plurality of received analog signals.

Meanwhile, in the receiver (RX), the analog beamformer 23 uses a plurality of phase adjusters 25 to adjust and combine the phases of reception signals received through a plurality of antennas 24 to generate a plurality of analog signals. The plurality of RF chains 22 convert the plurality of analog signals generated by the analog beamformer 23 into digital signals and apply them to the digital beamformer 21. The digital beamformer 21 acquires reception data by adjusting and combining the phases of the plurality of digital signals applied from the plurality of RF chains 22.

In the receiver (RX), the digital beamformer 21 can be referred to as a digital combiner that performs digital post-processing and combining on the applied digital data, and the analog beamformer 23 can be referred to as an analog combiner that performs analog post-processing and combining on the applied plurality of reception signals.

The target estimation module 30 receives and analyzes the reception data acquired from the digital beamformer 21 of the receiver (RX) when the ISAC device performs a sensing operation, thereby determining the presence and location of an object.

Although not shown, the ISAC device may further include a memory (not shown) that stores a beam codebook composed of a plurality of preset codes so that the digital beamformers 11 and 21 and the analog beamformers 13 and 23 code the applied data or signals to form a beam of a required shape, and a processor (not shown) that controls the operation of the digital beamformers 11 and 21 and the analog beamformers 13 and 23 according to the stored beam codebook.

In FIG. 1, the configuration of a transmitter (TX) and a receiver (RX) is illustrated separately for ease of understanding, but the transmitter (TX) and the receiver (RX) have the same configuration of digital beamformers 11 and 21, a plurality of RF chains 12 and 22, and analog beamformer 13 and 23, and can be distinguished differently depending on whether data or signals are processed in the forward or reverse direction. Accordingly, in the ISAC device used, the transmitter (TX) and receiver (RX) may be implemented as an integrated transceiver.

In a transmitter (TX) and receiver (RX) with this hybrid beamforming architecture, the digital beamformers 11 and 21 code the data applied according to a plurality of channel information distinguished by a plurality of subcarriers, while the analog beamformers 13 and 23 code the signals applied according to a plurality of antennas 14 and 24, thereby enabling transmission of the transmission signal or reception signal according to the shape of the beam formed. In addition, the analog beamformers 13 and 23 and digital beamformers 11 and 21 determine the beam shape to be generated based on channel states according to the distance and direction between the transmitter (TX) and receiver (RX), the frequency and bandwidth of the transmitted signal, etc., to maximize the array gain and multiplexing gain by the arrayed plurality of antennas 14 and 24, respectively, and then acquire a code according to the determined beam shape. Then, coding must be performed using the acquired code to form the beam.

As described above, in order for a transmitter (TX) and a receiver (RX) having a hybrid beamforming architecture to perform stable communication, a code according to a beam shape to be formed must first be acquired based on channel states for a plurality of channels between the transmitter (TX) and the receiver (RX).

When the number of multipath channels through which signals are transmitted between the transmitter (TX) and the receiver (RX) is L, a channel matrix (H) representing the overall channel state can be obtained using Equation 1.

$$H = {\sum }_{l = 1}^{L} {α}_{l} {Λ}_{r} ( {ϕ}_{l}^{r} , {θ}_{l}^{r} ) {Λ}_{t} ( {ϕ}_{l}^{t} , {θ}_{l}^{t} ) {a}_{r} ( {ϕ}_{l}^{r} , {θ}_{l}^{r} ) {a}_{t}^{*} ( {ϕ}_{l}^{t} , {θ}_{l}^{t} ) \qquad [ Equation 1 ]$$

Here, ai represents the path loss on the lth path among L multipaths, Λᵣ represents the directional pattern of the receiving antenna 24 determined by the azimuth (φₗ^{r}) and elevation angle (θₗ^{r}), and Λᵣ represents the directional pattern of the transmitting antenna 14 determined by the azimuth (φₗ^{t}) and elevation angle (θₗ^{t}). In addition, aᵣ and aₜ are array response vectors of the arrayed receiving antennas 24 and transmitting antennas 14, which indicate how the array of receiving antennas 24 and transmitting antennas 14 reacts to signals in the direction of azimuth (φₗ^{r}, φₗ^{r}) and elevation angles (θₗ^{r}, θₗ^{t}), and aₜ* represents the complex conjugate of aₜ.

When the ISAC device estimates the channel matrix (H) according to the beam sweeping technique, the beam shape to be formed to be directed to each of the plurality of zones that divide the entire communication target area is pre-specified. Since the required beam shape is pre-specified, a plurality of codes for forming the plurality of beams of the specified shape may also be pre-specified and stored as a beam codebook. Therefore, when estimating a channel using a beam sweeping technique, the transmitter (TX) sequentially forms beams in various directions according to the beam codebook and transmits a transmission signal, identifies when the receiver (RX) feeds back information about the transmitted signal and the beam with the highest gain from the information fed back from the receiver (RX), and selects it as a channel for performing communication. That is, in order to estimate the channel matrix (H), a process in which the receiver (RX) processes the received signal and provides feedback is absolutely necessary.

In contrast, during sensing operation, the receiver (RX) receives a signal radiated from the transmitter (TX) and reflected from an object. Therefore, in most cases, the azimuth (φₗ^{r}) and elevation (θₗ^{r}) of the receiver (RX) are identical to the azimuth (φₗ^{t}) and elevation (θₗ^{t}) of the transmitter (TX) (φₗ^{r}=φₗ^{t}, θₗ^{r}=θₗ^{t}). Therefore, the azimuth (øl′, ø11) and elevation (θₗ^{r}, θₗ^{t}) of the receiver (RX) and transmitter (TX) can be integrated and expressed as the azimuth (φₗ) and elevation (θₗ). Furthermore, since the azimuth (φₗ^{t}) and elevation (θₗ^{t}) of the transmitter (TX) are determined based on the beam shape to be formed, they can be easily readily identified. In particular, when the ISAC device is installed on a vehicle, the elevation (θₗ) component may be ignored due to the operational characteristics of the vehicle. Therefore, in the following, the angle refers to the azimuth (φ).

As described above, the transmitter (TX) and the receiver (RX) are often implemented as the same device, or, even when implemented separately, they share a single antenna in most cases. Therefore, since the array response vector (aₜ) of the transmitting antenna 14 and the array response vector (aᵣ) of the receiving antenna 24 are also the same (aₜ=aᵣ), they can be expressed as a single array response vector (a). That is, when only the azimuth (φₗ^{t}) and the array response vector (a) of the transmitter (TX) are identified, the channel matrix (Hₛ) can be easily estimated.

Therefore, when operating as a sensing device, the signal transmitted from the transmitter (TX) is not processed and fed back by the receiver (RX), but the reflected signal is received directly, so the intermediate processing step is omitted, allowing for faster channel estimation. Accordingly, the ISAC device has the advantage of facilitating channel estimation with low complexity by first estimating the channel using sensing information and subsequently utilizing the estimated channel information for communication.

However, since the ISAC device must serve not only as a sensing device but also as a communication device, a wide frequency bandwidth is required to enable transmission of a larger amount of data. However, as the frequency bandwidth increases, the frequency difference from the center frequency (f_{c}) to the minimum frequency (fₘᵢₘ) and maximum frequency (fₘₐₓ) increases significantly, resulting in beam squint phenomenon.

FIG. 3 is a diagram illustrating the beam squint phenomenon.

An array antenna having a plurality of antennas arranged therein is designed based on the center frequency (f_{c}) of the bandwidth. That is, the plurality of antennas are arranged at intervals of half the wavelength (λ₂) corresponding to the center frequency (f_{c}). Signals radiated from the plurality of antennas arranged at intervals of half the wavelength (λ_{c}) interfere with each other to focus the signal in a specific direction, thereby forming a beam. The array antenna designed based on the center frequency (f_{c}) in this way is highly sensitive to frequency variations. In particular, when the frequency bandwidth expands and the minimum frequency (fₘᵢₘ) and maximum frequency (fₘₐₓ) differ significantly from the center frequency (f_{c}), a beam squint phenomenon occurs, as illustrated in FIG. 3, where the beam direction deviates from the intended direction at the minimum frequency (fₘᵢₘ) and maximum frequency (fₘₐₓ). Such a beam squint phenomenon causes the beam direction error, which may prevent normal communication even despite channel estimation. Especially when used as a sensing device, there is a serious problem of misidentifying the location of obstacles.

Meanwhile, when the ISAC device performs communication, it usually communicates with a communication target that is located a certain distance away. In contrast, when performing sensing, it must be able to detect both distant and close-range objects. Especially when the ISAC device is applied to a vehicle or the like, it is very important to accurately detect close-range objects, which pose a higher risk of accidents than distant objects. However, when detecting close-range objects using a physically large array antenna for efficient beamforming in high-frequency bands, near-field effects, which are rarely considered in communications, occur.

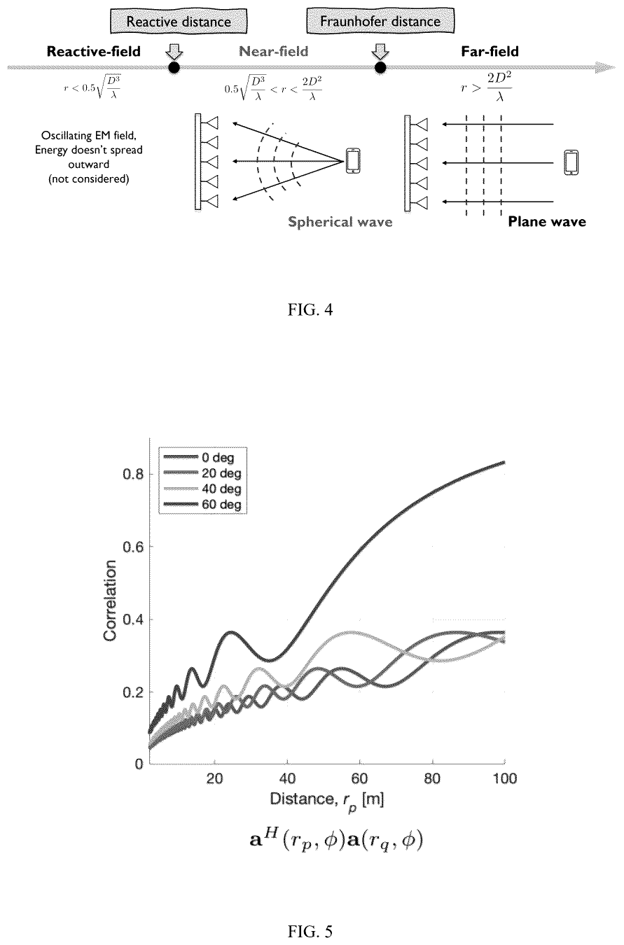

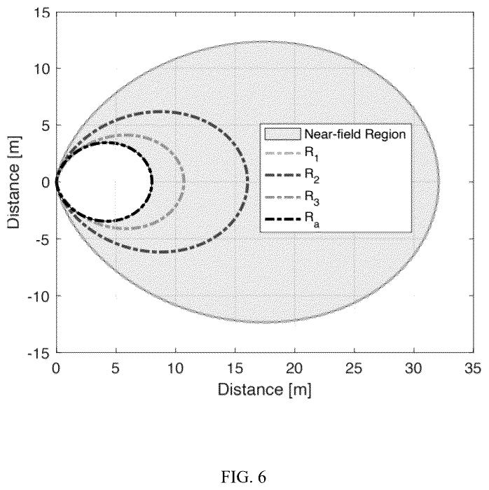

FIG. 4 is a diagram illustrating the near-field effect, FIG. 5 is a diagram illustrating analog sensing correlation in the near-field, and FIG. 6 is a diagram illustrating beam focusing in the near-field region.

As illustrated in FIG. 4, when the transmitter (TX) transmits a signal, the space may be divided into three regions according to the wavelength (λ) of the signal used and the diameter (D) of the array antenna. First, the reactive-field region on the left side corresponds to a close proximity range in which the distance (r) from the antenna 14 of the transmitter (TX) is

$$r < 0.5 \sqrt{\frac{{D}^{3}}{λ}} .$$

In this region, energy does not spread outward, rendering the region unusable; therefore, it is not considered for communication or sensing. The region on the right side, at a distance (r) of

$$r > \frac{2 {D}^{2}}{λ} ,$$

represents the far-field, commonly used for communication. The region midway between the reactive-field and far-field regions represents the near-field.

Basically, the signal radiated from each antenna spreads out as a spherical wave centered around the antenna, as shown in the near-field in the center of FIG. 2. As the distance (r) increases, the curvature of the spherical wave signal can be ignored, approximating it to a plane wave. In most communications, communication is performed with devices over long distances, so signals are processed assuming them to be approximate plane waves. In particular, during beamforming, the plane wave signals radiated from each of the plurality of antennas overlap to form a beam shape in an area where the gain is strengthened.

In contrast, the near-field region is a region close to the antenna, and refers to a region where it is difficult to approximate the radiated spherical wave signal as a plane wave. Due to the near-field effect, also known as the spherical wavefront effect, signals in the near-field region cannot be approximated as plane waves but must be processed as spherical waves. That is, in the near-field region, the beam is formed in a manner different from that of conventional beamforming. Moreover, as the frequency (f) of the signal used in ISAC devices increases, the wavelength (λ) decreases, and the area where the near-field effect occurs gradually increases.

As described above, in the far-field, the signal is assumed to be a plane wave, so only the beam direction needs to be considered, and thus beamforming is performed. However, in the near-field, even when beams are formed in a specific direction, the distance (r) at which the signals overlap varies. In other words, even in the same direction, there are distances where the beam intensity is strong and distances where it is weak, resulting in different beam intensities at different distances. Therefore, it is difficult to accurately detect objects located in the near-field region using a beamforming method that forms a beam by simply considering the sensing direction.

Specifically, when the ISAC device performs a sensing operation, the sensing signal transmitted by the transmitter (TX) according to the transmission data (x) is reflected by an object, and the sensing data (y) obtained from the sensing signal received by the receiver (RX) can be expressed as in Equation 2.

$$y = {W}_{BB}^{H} {W}_{RF}^{H} {H}_{S} {F}_{R F} {F}_{B B} x + {W}_{BB}^{H} {W}_{RF}^{H} n \qquad [ Equation 2 ]$$

Here, W_{BB} and W_{RF} are codes for coding signals to form beams by the digital beamformer 21 and analog beamformer 23 of the receiver (RX), F_{BB} and F_{RF} are codes for coding signals to form beams by the digital beamformer 11 and analog beamformer 13 of the transmitter (TX), and Hₛ is the entire channel matrix used for sensing. W_{BB}^{H} and W_{RF}^{H} represent conjugate transposes of W_{BB} and W_{RF}.

The digital beamformer 11 determines subcarriers to which symbol values obtained by precoding the sensing data (x) applied according to a digital code (F_{RF}) are to be allocated, and transmits the symbol values to a plurality of RF chains 12 according to the determined subcarriers. The analog signals converted from the plurality of RF chains 12 are applied to the analog beamformer 13, and the analog beamformer 13 adjusts and combines the phases of the analog signals applied from the plurality of RF chains 12 according to the analog code (F_{BB}) and transmits them to the plurality of antennas 14. In this case, signals radiated from the plurality of antennas 14 interfere with each other to form and transmit a sensing beam.

When a sensing signal is reflected from an object and a plurality of signals are received through the plurality of antennas 24 of the receiver (RX), the analog beamformer 23 phase-controls and combines the plurality of signals received according to an analog code and transmits them to the plurality of RF chains 22. In this process, signals received from a specific direction are emphasized, and signals received from other directions are relatively weakened. That is, the analog beamformer 23 forms a beam through which signals are received through the plurality of antennas 24 according to an analog code (W_{RF}), and receives a reception signal along the formed beam. The digital beamformer 21 receives a plurality of symbol values converted into digital values from the plurality of RF chains 22, codes them according to a digital code (W_{BB}), and obtains reception data (y).

However, noise (n) is added in the process of the sensing signal transmitted from the plurality of antennas 14 of the transmitter (TX) being received by the plurality of antennas 24 of the receiver (RX), and the added noise passes through the analog beamformer 23 and the digital beamformer 21 of the receiver (RX) in the same way as the reception signal. Therefore, the conjugate transposes (W_{BB}^{H}, W_{RF}^{H}) of the analog code (W_{RF}) and digital code (W_{BB}) are also applied to the noise (n).

As described above, when an ISAC device performs a sensing operation, the direction in which a signal reflected from an object is generally received is the same as the direction in which the signal was transmitted. In other words, the directions in which the sensing beam and the receiving beam are formed are the same, and therefore, the analog codes (F_{RF}, W_{RF}) of the transmitter (TX) and receiver (RX) can be said to be the same (F_{RF}=W_{RF}).

Meanwhile, in order for the ISAC device to detect an object, the signal-to-noise ratio (hereinafter, SNR) of the reception signal must be higher than the reference SNR. From Equation 2, the signal-to-noise ratio can be defined as in Equation 3.

$$S N R = \frac{{\vert {W}_{BB}^{H} {W}_{R F}^{H} {H}_{S} {F}_{R F} {F}_{BB} \vert}^{2}}{{\vert {W}_{B B}^{H} {W}_{RF}^{H} n \vert}^{2}} \qquad [ Equation 3 ]$$

When it is assumed that the digital beamformers 11 and 21 does not process the signal separately during sensing operation, but processes the signal according to the basic digital beam codebook (F_{BB}=W_{BB}=1), and when it is assumed that only the analog beamformers 13 and 23 process the signal to form a beam, a method for improving the SNR of Equation 3 is to adjust the analog codes (F_{RF}, W_{RF}) of the transmitter (TX) and receiver (RX). Therefore, the items to be considered in Equation 3 can be summarized in Equation 4.

$${W}_{R F}^{H} {H}_{S} {F}_{R F} = {αρ}_{eff} \qquad [ Equation 4 ]$$

Here, a is the path attenuation value, and per is the gain obtained by the digital beamformers 11 and 21 using a normalized analog beam without signal processing.

Here, the gain obtained by using a normalized analog beam is called analog sensing correlation, and the analog sensing correlation (ρ_{eff}) has a value closer to 1 as the direction of the formed beam and the position of the object are closer. However, this does not take into account the above-described beam squint effect and near-field effect. When the beam squint effect and near-field effect occur, the waveforms of the signals radiated from the plurality of antennas do not overlap precisely at the location of the object to be sensed, which lowers the analog sensing correlation (ρ_{eff}), resulting in a problem in which the SNR is lowered and the object cannot be detected normally.

FIG. 5 shows the change in analog sensing correlation (ρ_{eff}) according to distance (r) within the near-field region when forming beams at angles of 0, 20, 40, and 60 degrees, respectively. As shown in FIG. 5, it can be seen that the analog sensing correlation (ρ_{eff}) changes significantly depending on the distance (r) even when the direction of the formed beam is specified in the 0, 20, 40, and 60 degree directions. In particular, in the near-field region, the analog sensing correlation (ρ_{eff}) does not change linearly with distance (r), but as shown in FIG. 5, it can be seen that the pattern of increasing and decreasing in each section is repeated, although it increases overall with distance (r).

Therefore, in the near-field region where the near-field effect occurs, the sensing sensitivity changes depending on the distance (r), so a beam focusing method that focuses and forms a beam at a specific location must be employed, taking into account both the direction error due to the beam squint effect and the intensity change depending on the distance due to the near-field effect.

As illustrated in FIG. 5, in the near-field region, the analog sensing correlation (ρ_{eff}) increases and decreases repeatedly with distance, and has a pattern in which peaks appear at different distances for each angle. Therefore, in order to sense an object located within the near-field while changing the direction of the beam according to the beam sweeping technique, the object must be detected by applying a beam focusing method that forms the beam differently depending on the angle (φ) and distance (r), as illustrated in FIG. 6.

In FIG. 6, the largest outer elliptical region represents the periphery of the near-field region (NF region), and the smallest inner elliptical region represents the region according to the angular reactivity distance (Rₐ) where sensing cannot be performed. Here, it is assumed that the ISAC device is mounted on a vehicle, and in consideration of the characteristics of the vehicle, only the (φ) is taken into account, while the elevation (θ) is not considered.

As described above, in the near-field region, the analog sensing correlation (ρ_{eff}) increases and decreases repeatedly with distance. Therefore, in the past, in order to accurately detect an object located within the near-field region, a plurality of focusing distances (R) at which the analog sensing correlation (ρ_{eff}) appears high for each angle (φ) were designated, and the beam was focused at the designated angle (φ) and focusing distance (R). Consequently, the existing ISAC device performed sensing by dividing the near-field region, excluding the region according to the reactive distance (Rₐ), into a plurality of regions according to the combination of focusing distances (R₁, R₂, R₃) for each angle (φ) where the peak of the analog sensing correlation (ρ_{eff}) appears, and performing beam sweeping to sequentially focus the beam for each position according to the combination of focusing distances (R₁, R₂, R₃) for each angle (φ) in each of the divided regions, as illustrated in FIG. 5. In this case, the SNR of the reception data (y) is greatly increased in the region where the peak of the analog sensing correlation (ρ_{eff}) appears, so the object can be detected very accurately. However, when beam focusing is performed based on the location where the peak of the analog sensing correlation (ρ_{eff}) appears, the SNR decreases rapidly as the distance from that location increases, making it more difficult to detect objects in other locations. Consequently, the existing ISAC device repeatedly performed beam sweeping in each of a plurality of regions, which are divided into positions corresponding to combinations of focusing distances (R₁, R₂, R₃) for each angle (φ) at which the peak of the analog sensing correlation (ρ_{eff}) appears. And for this purpose, an analog beam codebook set corresponding to each of the plurality of divided regions was required. For example, in the case of FIG. 6, the beam sweeping had to be performed three times to accurately detect objects located within the near-field region, and in order to perform beam sweeping for each region, three analog beam codebook sets, each including analog codes designated to focus a beam at positions corresponding to the focusing distances (R₁, R₂, R₃) for each angle (φ), were required to be used. This causes the problem that not only must complex coding operations be performed repeatedly to detect objects within the near-field region, but it also takes a long time to detect objects.

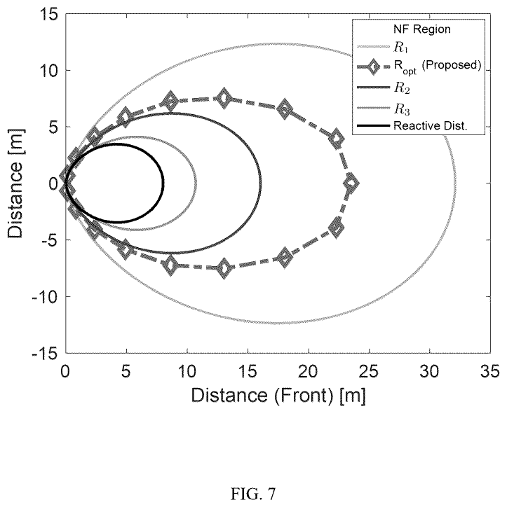

FIG. 7 is a diagram illustrating a single analog beam codebook set according to one embodiment.

In FIG. 6, the near-field region is divided into a plurality of regions in which beam focusing is to be performed, based on combinations of focusing distances (R₁, R₂, R₃) for each angle (φ) at which the peak of the analog sensing correlation (ρ_{eff}) appears. The SNR reaches its maximum at a position where the analog sensing correlation (ρ_{eff}) exhibits a peak, thereby allowing for highly accurate object detection. However, an object can still be sufficiently detected even at positions where the analog sensing correlation (ρ_{eff}) does not exhibit a peak, as long as the SNR is equal to or greater than the reference SNR.

Taking the above into account, the ISAC device of one embodiment defines a near-field analog sensing correlation

$$( {ρ}_{eff}^{NF} )$$

in which both the beam squint effect and the near-field effect are reflected, and extracts, for each angle (φ), a focusing distance (Rₒₚₜ) that enables detection of an object located within the entire near-field region without significant loss of SNR, even when beam sweeping is performed only once based on the defined near-field analog sensing correlation

$$( {ρ}_{eff}^{NF} ) .$$

In addition, a single analog beam codebook set is obtained such that beam focusing is performed at the extracted focusing distance (Rₒₚₜ) for each angle (φ), and based on the obtained single analog beam codebook set, objects in the near-field are detected. Since objects in the entire near-field region can be detected by performing beam sweeping only once, object detection can be performed with lower computational complexity compared to existing devices, enabling faster detection and reduced power consumption.

Hereinafter, a method for deriving the near-field analog sensing correlation

$$( {ρ}_{eff}^{NF} )$$

is described.

When beam focusing is to be performed for a signal of an arbitrary subcarrier frequency (fₘ) at a position of an arbitrary focusing distance (R) and an arbitrary angle (φ), the channel matrix (H) in Equation 1 can be re-expressed as the channel matrix (Hₛ) in Equation 5.

$${H}_{S} = α ( R , ϕ , {f}_{m} ) a ( R , ϕ , {f}_{m} ) {a}^{*} ( R , ϕ , {f}_{m} ) \qquad [ Equation 5 ]$$

Here too, α represents the path attenuation, a(R,φ,fₘ) is the array response vector of the antenna, and a*(R,φ,fₘ) represents the complex conjugate of a(R,φ,fₘ).

Here, it is assumed that the transmitter (TX) and receiver (RX) use the same array antenna and have the same directional pattern, and therefore the array response vectors (aₜ, aᵣ) of the transmitter (TX) and receiver (RX) are not distinguished, and are denoted as the same array response vector (a(R,φ,fₘ)).

When the analog beam codebooks of each transmitter (TX) and receiver (RX) for implementing beam focusing are (F_{RF}, W_{RF}), the near-field analog sensing correlation

$$( {ρ}_{eff}^{NF} )$$

considering the near-field effect and the beam squint effect from Equations 4 and 5 can be expressed as Equation 6.

$${ρ}_{eff}^{NF} = {w}_{RF} a ( R , ϕ , {f}_{m} ) {a}^{*} ( R , ϕ , {f}_{m} ) {f}_{RF} \qquad [ Equation 6 ]$$

In Equation 6, since the analog beam codebooks (F_{RF}, W_{RF}) of the transmitter (TX) and receiver (RX) are the same (F_{RF}=W_{RF}), in order for the near-field analog sensing correlation

$$( {ρ}_{eff}^{NF} )$$

to be maximized, the analog beam codebooks (F_{RF}, W_{RF}) and sensing correlation the array response vector (a(R,φ,fₘ)) must be the same (F_{RF}, W_{RF}=a(R,φ,fₘ)).

Accordingly, the near-field analog sensing correlation

$$( {ρ}_{eff}^{NF} ( R , r , ϕ , {f}_{m} ) )$$

at an arbitrary distance (r) for a beam focused at an arbitrary angle (φ) and focusing distance (R) can be defined by Equation 7.

$${ρ}_{eff}^{NF} ( R , r , ϕ , {f}_{m} ) = \vert \frac{1}{{N}_{T}} {\sum }_{n = 1}^{{N}_{T}} {e}^{- \frac{j 2 π}{{c}_{0}} sin ( ϕ ) ( {f}_{c} - {f}_{m} ) nd} {e}^{- \frac{j 2 π}{{c}_{0}} {cos}^{2} ( ϕ ) ( \frac{{f}_{m}}{2 r} - \frac{{f}_{c}}{2 R} ) {( nd )}^{2}} \vert \qquad [ Equation 7 ]$$

Here,

$${ρ}_{eff}^{NF} ( R , r , ϕ , {f}_{m} )$$

is the near-field analog sensing correlation

$$( {ρ}_{eff}^{NF} )$$

for an object located at an arbitrary distance (r) when a signal using a subcarrier of frequency (fₘ) is beam-focused at a location of focusing distance (R) and angle (φ), N_{T} represents the number of antennas, c₀ represents the speed of light in vacuum, and f_{c} represents the median frequency of the entire band. In addition, d represents the spacing between a plurality of antennas of the array antenna.

In addition, in the near-field analog sensing correlation

$$( {ρ}_{eff}^{NF} ( R , r , ϕ , {f}_{m} ) )$$

of Equation 7, item

$${e}^{- \frac{j 2 π}{{c}_{0}} sin ( ϕ ) ( {f}_{c} - {f}_{m} ) nd}$$

is an item reflecting the beam squint effect, and item

$${e}^{- \frac{j 2 π}{{c}_{0}} {cos}^{2} ( ϕ ) ( \frac{{f}_{m}}{2 r} - \frac{{f}_{c}}{2 R} ) {( nd )}^{2}}$$

is an item reflecting the near-field effect.

Since the near-field analog sensing correlation

$$( {ρ}_{eff}^{NF} ( R , r , ϕ , {f}_{m} ) )$$

can only be applied in the near-field region, referring to FIG. 7, the distance (r) must have a value greater than or equal to Rₐ and less than or equal to R₁ (Rₐ≤r≤R₁).

Meanwhile, based on Equation 7, the single angle-specific distance (R_{SPC}(φ)) for detecting an object through one-time sweeping using a single analog beam codebook set, while minimizing SNR loss across the entire near-field region, can be formulated as shown in Equation 8.

$${R}_{SPC} ( ϕ ) = arg {max}_{R ∈ r} [ {\int }_{{R}_{a} ( ϕ )}^{{R}_{1} ( ϕ )} p ( r ) \frac{1}{M} {\sum }_{{f}_{m}} \vert {ρ}_{eff}^{NF} ( R , r , ϕ , {f}_{m} ) \vert dr ] \qquad [ Equation 8 ]$$

Here, p(r) denotes the probability distribution function of the sensing target with respect to the distance (r), and, for convenience, it is assumed to follow a uniform probability distribution

$$( p ( r ) = \frac{1}{{R}_{1} ( ϕ ) - {R}_{a} ( ϕ )} ) .$$

In addition, M denotes the total number of subcarriers.

Once the single angle-specific focusing distance (R_{SPC}(φ)) is obtained according to the near-field analog sensing correlation

$$( {ρ}_{eff}^{NF} ( R , r , ϕ , {f}_{m} ) )$$

by Equation 8, objects within the near-field region can be detected through one-time sweeping using a single analog beam codebook set configured to focus the beam at the focusing distance (R_{SPC}) according to the angle (φ).

In an illustrated embodiment, respective configurations may have different functions and capabilities in addition to those described above, and may include additional configurations in addition to those described above. In addition, in an embodiment, each configuration may be implemented using one or more physically separated devices, or may be implemented by one or more processors or a combination of one or more processors and software, and may not be clearly distinguished in specific operations unlike the illustrated example.

In addition, each component of the ISAC device illustrated in FIG. 1 may be implemented in a logic circuit by hardware, firm ware, software, or a combination thereof or may be implemented using a general purpose or special purpose computer. The apparatus may be implemented using hardwired device, field programmable gate array (FPGA) or application specific integrated circuit (ASIC). Further, the apparatus may be implemented by a system on chip (SoC) including one or more processors and a controller.

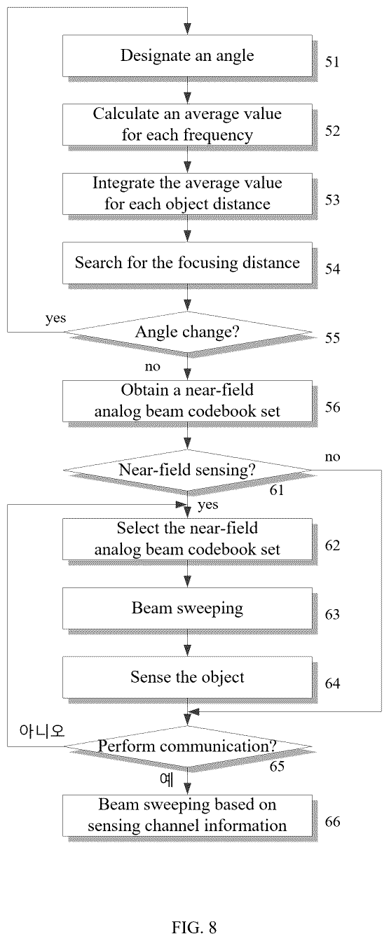

FIG. 8 illustrates an operating method of an integrated sensing and communication device according to one embodiment.

Referring to FIG. 8, the ISAC device of one embodiment first performs a step of generating a near-field analog beam codebook set.

In the step of generating a near-field analog beam codebook set, an arbitrary angle (φ) is first designated within the required sensing angle range (51). Then, at the designated angle (φ) and focusing distance (R), the average value of the near-field analog sensing correlation

$$( {ρ}_{eff}^{NF} ( R , r , ϕ , {f}_{m} ) )$$

for each of the frequencies (fₘ) of a plurality of subcarriers, with respect to the object distance (r), is calculated (52). The product of the calculated average value of the near-field analog sensing correlation

$$( {ρ}_{eff}^{NF} ( R , r , ϕ , {f}_{m} ) )$$

and the sensing target probability distribution (p(r)) is integrated with respect to the object distance (r) to calculate the integral value (53).

The process of calculating the integral value while varying the focusing distance (R) is repeated, and the focusing distance (R) with the largest integral value is searched for to obtain the single angle-specific focusing distance (R_{SPC}(φ)) at the current angle (φ) (54).

Then, it is determined whether to repeat the process of changing the angle (φ) to obtain a single angle-specific focusing distance (R_{SPC}(φ)) again (55). When the angle-specific focusing distance (R_{SPC}(φ)) needs to be obtained at a different angle, the process of changing the angle (φ) to obtain a single angle-specific focusing distance (R_{SPC} (φ)) is repeated. In this case, the angle (φ) may be varied in uniform increments within the designated sensing angle range.

However, when it is determined that all the required angle-specific single beam focusing distances (R_{SPC}(φ)) within the sensing angle range have been obtained, the subcarrier frequency (fₘ), angle (φ), and angle-specific single beam focusing distances (R_{SPC}(φ)) have been determined. In addition, during the sensing operation of ISAC, the analog beam codebooks (F_{RF}, W_{RF}) of the transmitter (TX) and the receiver (RX) must be identical (F_{RF}=W_{RF}). Accordingly, an analog beam codebook (F_{RF}, W_{RF}) satisfying Equation 6 is obtained from a plurality of angle-specific single beam focusing distances (R_{SPC}(φ)) (56). Since the analog beam codebook (F_{RF}, W_{RF}) is obtained for each angle (φ), a plurality of analog beam codebooks (F_{RF}, W_{RF}) are obtained at a plurality of angles (φ) within the near-field region. In other words, a near-field analog beam codebook set is obtained.

Once the analog beam codebook set is obtained, the ISAC device may repeatedly perform beam focusing according to each of a plurality of analog beam codebooks in the obtained analog beam codebook set to detect an object located within the near-field in a beam sweeping manner.

Although the process of obtaining a near-field analog beam codebook set is separately illustrated here, the near-field analog beam codebook set may be obtained and stored in advance before actual operation of the ISAC device.

Afterwards, in the step of operating the ISAC device, it is determined whether to perform near-field sensing (61). The ISAC device can be used to sense objects at longer distances as well as near-field sensing, but for convenience of explanation, it is assumed here that it performs only near-field sensing.

When it is determined that the ISAC device performs near-field sensing, the stored near-field analog beam codebook set is selected (62). Then, beam sweeping is performed by sequentially performing beam focusing by alternately selecting analog beam codebooks (F_{RF}, W_{RF}) according to multiple angles (φ) included in the near-field analog beam codebook set (63). Then, while performing beam sweeping, the obtained reception data (y) is analyzed to sense the object.

Meanwhile, the ISAC device determines whether to perform communication (65). When the ISAC device is determined to be performing communication, the device may perform beam sweeping to search for a communication target device based on a sensing channel matrix (Hₛ) identified in the process of performing beam sweeping to perform sensing, and perform communication with the searched communication target device.

In FIG. 8, it is described that respective processes are sequentially executed, which is, however, illustrative, and those skilled in the art may apply various modifications and changes by changing the order illustrated in FIG. 8 or performing one or more processes in parallel or adding another process without departing from the essential gist of the exemplary embodiment of the present disclosure.

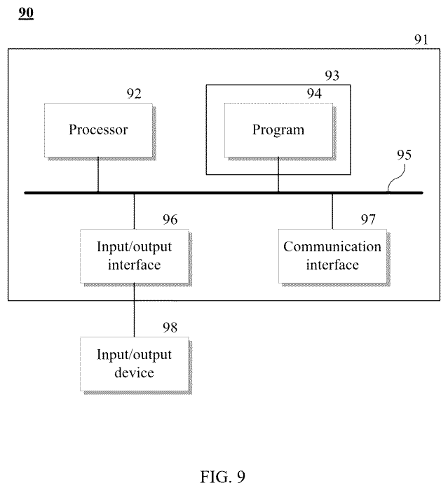

FIG. 9 is a diagram illustrating a computing environment including a computing device according to one embodiment.

In the illustrated embodiment, respective configurations may have different functions and capabilities in addition to those described below, and may include additional configurations in addition to those described below. The illustrated computing environment 90 may include a computing device 91 to perform the operating method of the ISAC device illustrated in FIG. 9. In an embodiment, the computing device 91 may be one or more components included in the ISAC device illustrated in FIG. 1.

The computing device 91 includes at least one processor 92, a computer readable storage medium 93 and a communication bus 95. The processor 92 may cause the computing device 91 to operate according to the above-mentioned exemplary embodiment. For example, the processor 92 may execute one or more programs 94 stored in the computer readable storage medium 93. One or more programs 94 may include one or more computer executable instructions, and the computer executable instructions may be configured, when executed by the processor 92, to cause the computing device 91 to perform operations in accordance with the exemplary embodiment.

The communication bus 95 interconnects various other components of the computing device 91, including the processor 92 and the computer readable storage medium 93.

The computing device 91 may also include one or more input/output interfaces 96 and one or more communication interfaces 97 that provide interfaces for one or more input/output devices 98. The input/output interfaces 96 and the communication interfaces 97 are connected to the communication bus 95. The input/output devices 98 may be connected to other components of the computing device 91 through the input/output interface 96. Exemplary input/output devices 98 may include input devices such as a pointing device (such as a mouse or trackpad), keyboard, touch input device (such as a touchpad or touchscreen), voice or sound input device, sensor devices of various types and/or photography devices, and/or output devices such as a display device, printer, speaker and/or network card. The exemplary input/output device 98 is one component constituting the computing device 91, may be included inside the computing device 91, or may be connected to the computing device 91 as a separate device distinct from the computing device 91.

The present disclosure has been described in detail through a representative embodiment, but those of ordinary skill in the art to which the art pertains will appreciate that various modifications and other equivalent embodiments are possible from this. Therefore, the true technical protection scope of the present invention should be determined by the technical spirit set forth in the appended scope of claims.

What is claimed is:

1. A method of operating an integrated sensing and communication device comprising the steps of:
digitally precoding input data according to a digital beam codebook;
receiving the precoded input data and converting the precoded input data into an analog signal; and
transmitting, during a sensing operation in a near-field region where a near-field effect is reflected in which a signal radiated from an array antenna appears as a spherical waveform, a sensing signal obtained by analog precoding the analog signal according to a near-field analog beam codebook set so that a beam is focused at a position of a plurality of designated angles and focusing distances within the near-field region and beam sweeping is performed once, to a plurality of antennas of the array antenna,
the near-field analog beam codebook set being obtained by repeatedly calculating and accumulating a near-field analog sensing correlation that represents a position-specific gain reflecting a squinting effect and the near-field effect according to a frequency difference between a center frequency of a bandwidth and a subcarrier frequency while adjusting a distance at which an object is detected at a designated angle and a focusing distance, and extracting the focusing distance that maximizes the accumulated near-field analog sensing correlation while the focusing distance changes at each designated angle within the near-field region.

2. The method of operating an integrated sensing and communication device according to claim 1,
wherein the near-field analog sensing correlation is calculated according to Equation
$${ρ}_{eff}^{NF} ( R , r , ϕ , {f}_{m} ) = \vert \frac{1}{{N}_{T}} {\sum }_{n = 1}^{{N}_{T}} {e}^{- \frac{j 2 π}{{c}_{0}} sin ( ϕ ) ( {f}_{c} - {f}_{m} ) nd} {e}^{- \frac{j 2 π}{{c}_{0}} {cos}^{2} ( ϕ ) ( \frac{{f}_{m}}{2 r} - \frac{{f}_{c}}{2 R} ) {( nd )}^{2}} \vert$$
$$( wherein , {ρ}_{eff}^{NF} ( R , r , ϕ , {f}_{m} )$$
is the near-field analog sensing correlation for an object located at an arbitrary distance (r) when a signal using a subcarrier of frequency (fₘ) is beam-focused at a location of the focusing distance (R) and angle (φ), Nr represents the number of antennas in the array antenna, c₀ represents the speed of light in vacuum, and f_{c} represents the median frequency. In addition, d represents the spacing between a plurality of antennas of the array antenna.).

3. The method of operating an integrated sensing and communication device according to claim 2,
wherein the focusing distance is extracted according to Equation
$${R}_{SPC} ( ϕ ) = arg {max}_{R ∈ r} [ {\int }_{{R}_{a} ( ϕ )}^{{R}_{1} ( ϕ )} p ( r ) \frac{1}{M} {\sum }_{{f}_{m}} \vert {ρ}_{eff}^{NF} ( R , r , ϕ , {f}_{m} ) \vert dr ]$$
(wherein, p(r) is the probability distribution function of the sensing target according to the distance (r), and M represents the total number of subcarriers).

4. The method of operating an integrated sensing and communication device according to claim 2,
wherein the method includes:
receiving, during a sensing operation, a reception signal obtained by a signal transmitted by beam focusing from the array antenna being reflected by an object and received, adjusting and combining a phase according to the analog beam codebook to obtain an analog signal;
converting the obtained analog signal into a digital signal;
post-processing and combining the converted digital signal according to the digital beam codebook to obtain reception data; and
detecting the object by analyzing the obtained reception data.

5. The method of operating an integrated sensing and communication device according to claim 4,
wherein the near-field analog beam codebook set includes a plurality of analog beam codebooks that form a beam focused at each location of the focusing distance extracted for each angle.

6. The method of operating an integrated sensing and communication device according to claim 5,
wherein the analog beam codebooks are obtained so that the calculated near-field analog sensing correlation
$$( {ρ}_{eff}^{NF} ( R , r , ϕ , {f}_{m} ) )$$
is equal to the near-field analog sensing correlation
$$( {ρ}_{eff}^{NF} )$$
calculated according to Equation correlation
$${ρ}_{eff}^{NF} = {w}_{RF} a ( R , ϕ , {f}_{m} ) {a}^{*} ( R , ϕ , {f}_{m} ) {f}_{RF}$$
(wherein, F_{RF} and W_{RF} are the same (F_{RF}=W_{RF}) analog beam codebook, a(R,φ,fₘ) is the array response vector of the array antenna, and a*(R,φ,fₘ) is the complex conjugate of a (R,φ,fₘ)).

7. The method of operating an integrated sensing and communication device according to claim 6,
wherein the method includes: setting, during a communication operation, the near-field analog sensing correlation
$$( {ρ}_{eff}^{NF} )$$
obtained by the sensing operation as an analog sensing correlation (ρ_{eff}); obtaining a channel matrix according to Equation
$${W}_{RF}^{H} {H}_{S} {F}_{RF} = {αρ}_{eff}$$
(wherein, Hₛ represents the channel matrix and a represents the path attenuation)
based on the set analog sensing correlation (ρ_{eff}); and performing communication with a communication target device based on the obtained channel matrix.

8. The method of operating an integrated sensing and communication device according to claim 1,
wherein the step of digitally precoding includes performing digital precoding according to a basic digital precoder during near-field sensing operation.

9. The method of operating an integrated sensing and communication device according to claim 1,
wherein the method is performed by a memory, and a processor of a device including the processor and the memory.

10. An integrated sensing and communication device comprising:
a digital beamformer that digitally precodes input data according to a digital beam codebook;
a plurality of RF chains that receive the digitally precoded input data and convert the digitally precoded input data into an analog signal; and
an analog beamformer that transmits, during a sensing operation in a near-field region where a near-field effect is reflected in which a signal radiated from an array antenna appears as a spherical waveform, a sensing signal obtained by analog precoding the analog signal according to a near-field analog beam codebook set so that a beam is focused at a position of a plurality of designated angles and focusing distances within the near-field region and beam sweeping is performed once, to a plurality of antennas of the array antenna,
the near-field analog beam codebook set being obtained by repeatedly calculating and accumulating a near-field analog sensing correlation that represents a position-specific gain reflecting a squinting effect and the near-field effect according to a frequency difference between a center frequency of a bandwidth and a subcarrier frequency while adjusting a distance at which an object is detected at a designated angle and a focusing distance, and extracting the focusing distance that maximizes the accumulated near-field analog sensing correlation while the focusing distance changes at each designated angle within the near-field region.

11. The integrated sensing and communication device according to claim 10,
wherein the near-field analog sensing correlation is calculated according to Equation
$${ρ}_{eff}^{NF} ( R , r , ϕ , {f}_{m} ) = \vert \frac{1}{{N}_{T}} {\sum }_{n = 1}^{{N}_{T}} {e}^{- \frac{j 2 π}{{c}_{0}} sin ( ϕ ) ( {f}_{c} - {f}_{m} ) nd} {e}^{- \frac{j 2 π}{{c}_{0}} {cos}^{2} ( ϕ ) ( \frac{{f}_{m}}{2 r} - \frac{{f}_{c}}{2 R} ) {( nd )}^{2}} \vert$$
$$( wherein , {ρ}_{eff}^{NF} ( R , r , ϕ , {f}_{m} )$$
is the near-field analog sensing correlation for an object located at an arbitrary distance (r) when a signal using the subcarrier of frequency (fₘ) is beam-focused at a location of focusing distance (R) and angle (φ), N_{T} represents the number of antennas in the array antenna, c₀ represents speed of light in vacuum, and f_{c} represents a median frequency. In addition, d represents spacing between a plurality of antennas of the array antenna.).

12. The integrated sensing and communication device according to claim 11,
wherein the focusing distance is extracted according to Equation
$${R}_{SPC} ( ϕ ) = arg {max}_{R ∈ r} [ {\int }_{{R}_{a} ( ϕ )}^{{R}_{1} ( ϕ )} p ( r ) \frac{1}{M} {\sum }_{{f}_{m}} \vert {ρ}_{eff}^{NF} ( R , r , ϕ , {f}_{m} ) \vert dr ]$$
(wherein, p(r) is a probability distribution function of a sensing target according to the distance (r), and M represents the total number of subcarriers).

13. The integrated sensing and communication device according to claim 11,
wherein the integrated sensing and communication device further comprises
a target estimation module that, when a reception signal, obtained by a signal transmitted by beam focusing from the array antenna being reflected by an object and received, is obtained as reception data through the analog beamformer, the plurality of RF chains, and the digital beamformer, analyzes the reception data to detect an object.

14. The integrated sensing and communication device according to claim 13,
wherein the near-field analog beam codebook set includes a plurality of analog beam codebooks that form a beam focused at each location of the focusing distance extracted for each angle.

15. The integrated sensing and communication device according to claim 14,
wherein the analog beam codebooks are obtained so that the calculated near-field analog sensing correlation
$$( {ρ}_{eff}^{NF} ( R , r , ϕ , {f}_{m} ) )$$
is equal to the near-field analog sensing correlation
$$( {ρ}_{eff}^{NF} )$$
calculated according to Equation
$${ρ}_{eff}^{NF} = {w}_{RF} a ( R , ϕ , {f}_{m} ) {a}^{*} ( R , ϕ , {f}_{m} ) {f}_{RF}$$
(wherein, F_{RF} and W_{RF} are the same (F_{RF}=W_{RF}) analog beam codebook, a(R,φ,fₘ) is the array response vector of the array antenna, and a*(R,φ,fₘ) is the complex conjugate of a (R,φ,fₘ)).

16. The integrated sensing and communication device according to claim 15,
wherein the analog beamformer sets, during a communication operation, the near-field analog sensing correlation
$$( {ρ}_{eff}^{NF} )$$
obtained by the sensing operation as an analog sensing correlation (ρ_{eff}), obtains a channel matrix according to Equation
$${W}_{RF}^{H} {H}_{S} {F}_{RF} = {αρ}_{eff}$$
(wherein, Hₛ represents the channel matrix and a represents the path attenuation)
based on the set analog sensing correlation (ρ_{eff}), and performs communication with a communication target device based on the obtained channel matrix.

17. The integrated sensing and communication device according to claim 10,
wherein the digital beamformer performs digital precoding according to a basic digital precoder during near-field sensing operation.
